(19) United States
(12) Patent Application Publication
(10) Pub. No.: US 2010/0072297 A1
(43) Pub. Date: Mar. 25, 2010

(54) Method for controlling hurricanes

(76) Inventors: Manilal J. Savla, Manalapan, NJ (US); Vishal T. Shah, Parlin, NJ (US)

Correspondence Address: Manilal J. Savla, 160 Colony Lane, Manalapan, NJ, 07726, US

(21) Appl. No.: 12/586,102

(22) Filed: Sep. 17, 2009

Related U.S. Application Data
(60) Provisional application No. 61/194,038, filed on Sep. 24, 2008.

(51) Int. Cl. A01G 15/00

(52) U.S. Cl. 239/14.1

(57) ABSTRACT

A method for controlling hurricanes by raising temperature in the eye and/or in the outflow. Air temperature within the eye and in the outflow of a hurricane is raised by flying scores of jet planes with afterburners in the structure. Small changes in temperature on a large scale bring in large changes in other variables on the smaller scale to change the direction and intensity of the hurricane.

### CROSS-REFERENCE TO RELATED APPLICATIONS

Provisional patent application No. 61/194,038 dated Sep. 24, 2008

### BACKGROUND OF THE INVENTION

1. Field

This invention relates generally to controlling hurricanes or modifying the weather and in particular to the use of jet planes with afterburners to raise ambient temperature within the structure of a hurricane enough to change its direction and/or wind speeds.

2. Prior Art

Hurricanes, cyclones, typhoons, and the like weather patterns can cause severe damage to land, buildings, and living creatures. The resulting damage from even an isolated event can be billions of dollars as evidenced by Hurricane Katrina in 2005 and Ike in 2008.

Cloud seeding is a known process for artificially modifying the weather by injecting a composition into a cloud for formation of an ice freezing nuclei. Silver iodide is a well known substance used for cloud seeding. The Stormfury project carried out by the US Government for several years focused on hurricane formation suppression by means of aerial dispersion of silver iodide. This project was evaluated as a failure and cancelled.

U.S. Pat. No. 4,141,274 discloses a weather modification cartridge dispenser for automatically igniting and dispensing pyrotechnic rounds wherein the dispenser is basically a motor driven automatic spring powered gun.

U.S. Pat. No. 4,470,544 discloses cooling of the surface of the sea in the summer time by mixing surface water with cooler deep water, this being achieved by pumping water from a lower level of the sea to the upper level. This causes reduction in the heat lost during the summer whereby the amount of heat stored in the body of water during the summer is increased causing wintertime modification of the weather over the continental arid zone.

In 1976, William Gray et al suggested that the use of carbon black (or soot) might be a good way to modify tropical cyclones. The idea was that one could burn a large quantity of a heavy petroleum to produce vast numbers of carbon black particles that would be released on the edges of the tropical cyclone in the boundary layer. These carbon black aerosols would produce a heat source simply by absorbing the solar radiation and transferring the heat directly to the atmosphere. This would provide for the initiation of thunderstorm activity outside of the tropical cyclone core and weaken the eyewall convection. In 1958, the US Naval Research laboratory carried out some experiments to monitor clouds seeded with soot but the results were inconclusive.

U.S. Pat. No. 5,984,239 teaches about Satellite Weather Modification System. It is an aerospace system designed to harness solar energy to modify the earth's weather. This invention involves placing at least one million satellites in a planetary orbit, each satellite being capable of reflecting solar radiation.

U.S. Pat. No. 6,315,213 discloses a method for artificially modifying the weather by seeding rain clouds of a storm with a suitable cross-linked aqueous polymer. The super absorbent polymer is dispersed into the cloud and the wind of the storm agitates the mixture causing the polymer to absorb the rain. This reaction forms a gelatinous substance which precipitates to the surface below, thus, diminishing the velocity of the clouds.

United States Patent Application 20070114298 discloses delivering a coolant such as cryogenic air, liquid nitrogen, dry ice etc to bring about abatement of a hurricane by the dehydration of the moisture laden air.

United States Patent Application 20080047480 proposes a giant machine and method of operation to control hurricanes. The machine is a huge ship which is placed in the hurricane eyewall near the hurricane eye. The machine would mechanically blow air from the eyewall to the eye. The machine would bend the eyewall so that the eyewall would be diverted into the eye. The machine would slow down the air in the eyewall and the low pressure in the eye would suck the air in.

United States Patent Application 20080023566 discloses a similar giant device which blows sea water instead of air in or near the eyewall to reduce the strength of hurricane.

United States Patent Application 20080035750 discloses ways to reduce cyclonic wind damage. These include use of a variety of explosives.

Thus, the prior art teachings are directed to methods of creating rain or some impractical methods to modify weather. Most fail to appreciate the size and power of hurricanes.

### ADVANTAGES

Accordingly, several advantages of one or more aspects of the invention are practicality, immediate adaptation and little investment required.

Other Advantages of one or more aspects are savings of billions of dollars in storm damages and of lives by controlling hurricanes.

Further advantages will become apparent from a consideration of the ensuing description and the accompanying drawings.

### SUMMARY

In accordance with the invention, one or more aspects of weather modification are disclosed. One aspect is a method for controlling hurricanes by raising temperature in the eye and/or in the outflow. Air temperature within the eye and/or in the outflow of a hurricane is raised by flying a fleet of jet planes with afterburners in the structure. Small changes in temperature on a large scale bring in large changes in other variables on the smaller scale to change the direction and speed of the hurricane. The rise of temperature above the eye reduces the flow of air within the hurricane and slows it down. The rise of temperature within the eye increases pressure within the eye thus diminishing the strength of the hurricane. The number of jet planes and their locations can be selected based on a computer simulation for a desired change in the direction of the hurricane. This can help to avoid hurricane landing on a highly populated region or to steer it away from land.

Hurricanes, cyclones, typhoons, and the like weather patterns can cause severe damage to land, buildings, and living creatures. Billions of dollars in damage and loss of life even from an isolated storm can be prevented or reduced by adapting this invention.

This is a practical and environmentally safe method which can be adapted immediately without any huge investment.

### DRAWINGS

FIG. 1 shows an F/A18-C jet plane on a ground in different views.

FIG. 2 is a top view of a hurricane and shows flights of F/A-18 jet planes with afterburners in the outflow of the hurricane. A fleet of 200 aircraft flies in concentric circles above the eye.

FIG. 3 shows another top view with the jet planes flying in selected positions on top of the eyewall.

FIG. 4 shows a cross-sectional side view of the hurricane with jet planes flying through out the eye of the hurricane

FIG. 5 shows a cross-sectional side view of the hurricane with the jet planes flying in the center of the eye from the bottom of the eye to the top of the eye.

### DETAILED DESCRIPTION

The present invention relates a method for controlling hurricanes by raising temperature in the eye and in the outflow layer. Outflow is the air that exits the eye of the hurricane. Air temperature within the eye and in the outflow of a hurricane is raised by flying scores of jet planes with afterburners in the structure. Small changes in temperature on a large scale bring in large changes in other variables on the smaller scale to change the direction and speed of the hurricane. This is a practical and environmentally safe method which can be adapted immediately without any huge investment. The US National Oceanic and Atmospheric Organization and other US agencies fly planes through hurricanes routinely to do research and collect scientific data.

In recent research supported by the NASA Institute for Advanced Concept, Ross Hoffman advanced his theory of “chaotic” system. This theory of so-called “butterfly effect” shows that a small nudge in a chaotic system, for example hurricane, can produce chain reaction big enough to knock the hurricane off its course and also reduce its strength. Computer simulations of small changes in temperature showed control of track and intensity of hurricanes. One plausible approach suggested for actual hurricane control was to use microwave energy to heat up selected portions of hurricane using a ring of solar satellites. However, this solution is still far away many years for practical use.

This invention proposes to bring about small changes in temperature by using a fleet of flying jet planes with afterburners. Flight patterns, locations in the hurricane structure and number of aircrafts as well as duration of flights are determined doing a computer simulation using an appropriate software program.

The present invention is illustrated by examples of jet planes flying patterns shown as follows. Any suitable jet planes may be used but as an illustration F/A18-C jet is selected.

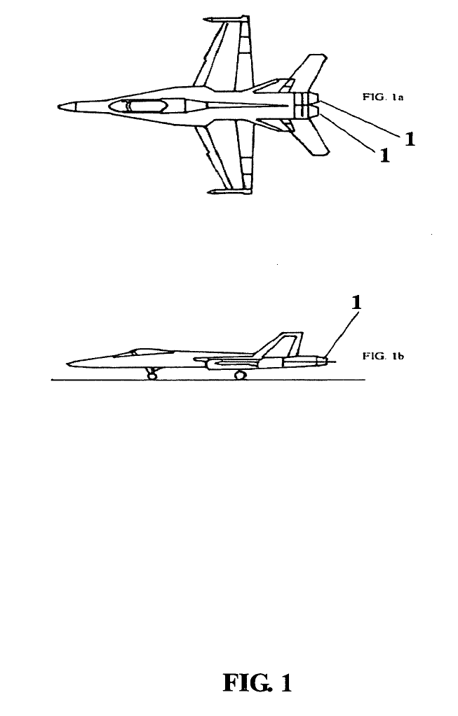

FIG. 1 shows an F/A18-C jet plane on a ground in different views. FIG. 1a is a plan view from top. FIG. 1b is a side view. The plane has a length of 56 ft., wingspan of 37.5 ft. and height of 15.25 ft. Afterburners 1 provide extra thrust in flight. However, for this invention they are used to raise temperature of the atmosphere.

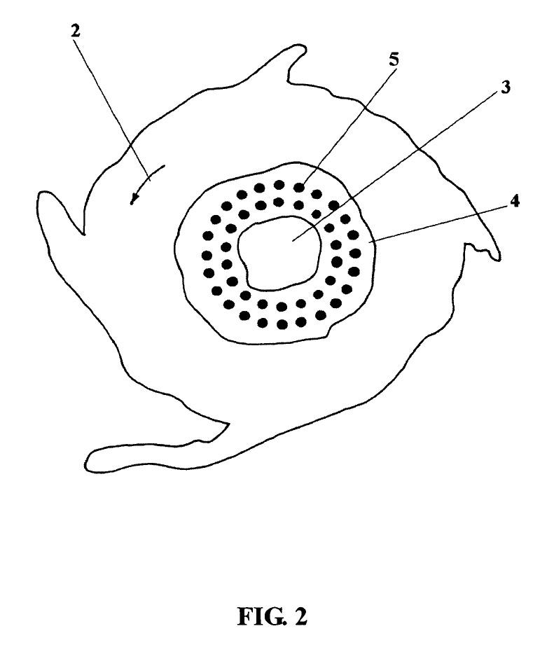

FIG. 2 shows flights of F/A jet planes 5 with afterburners in the outflow of a hurricane above the eyewall. The arrow 2 shows the direction of the hurricane which in the Northern Hemisphere rotates in a counterclockwise direction. A fully developed hurricane consists of a distinct eye 3 and eyewall 4. A fleet of 200 jet planes 5 flies for 1 hour above the hurricane in the outflow near the eye to heat up an atmospheric volume of about 50 kilometer in diameter and 100 meter in depth by nearly 1 degree Celcius. This reduces the flow of air within the hurricane and slows it down. The change in temperature is calculated as follows:

A typical eye diameter of high strength hurricane is 30 km in diameter.

Volume of atmosphere above the eye in 25 km radius and 100 meter height=Qa=3.14×25×25×0.1 cubic km=196.25 cubic km=196.25×10⁹ cubic meter.

F/A-18 C's maximum flying range with maximum fuel load is 2070 miles with maximum speed of 1190 mph. It can hold a maximum fuel of about 18,000 pounds.

Volume of exhaust from 200 F-18's twin GE F404-402 engines flying for 1 hour=Qe

F404-402's airflow specification is 146.5 lb/sec.

Assuming air density of 1.1 kg/m³,

Qe=(200×2×146.5/2.204×3600)/1.1 m³

=95.7×10⁶ m³

Assuming heat capacity of cold and hot air about equal, temperature Tm of mixed air can be calculated as follows:

Tm=(Qa×Ta+Qe×Te)/Qa+Qe

Where Ta=temperature of atmosphere above the eye=−50° C.=223° K.

And Te=temperature of afterburner exhaust=1500° C.=1773° K.

So Tm=(196.25×10⁹×223+95.7×10⁶×1773)/196.25×10⁹+95.7×10⁶=223.75° K.

Thus, atmospheric temperature above the eye is increased by 0.75° C. by flying the planes for 1 hour. The flight times can be increased if desired to increase the temperature further. The planes may be refueled in air if required. The fleet may be replaced if required.

The planes may also fly without the afterburners. However, the time required to attain required temperature raise will be much longer as the temperature of exhaust without the afterburners is not that high.

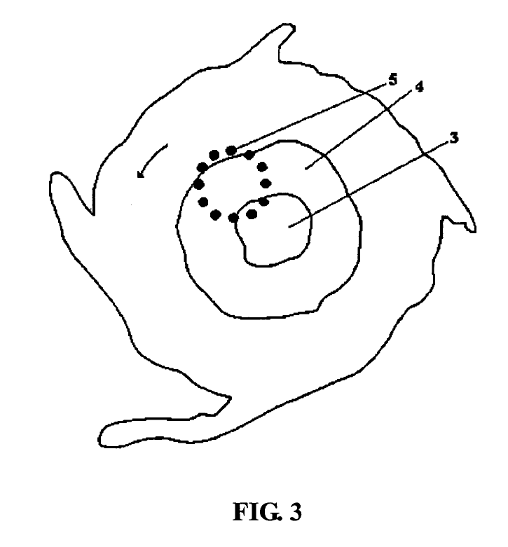

FIG. 3 shows jet planes 5 flying in selected positions on top of the eyewall 4 near the eye 3 of the hurricane. The number of jet planes 5 and their locations are selected based on a computer simulation for a desired change in the direction of the hurricane. This can help to avoid hurricane landing on a highly populated region or to steer it away from land.

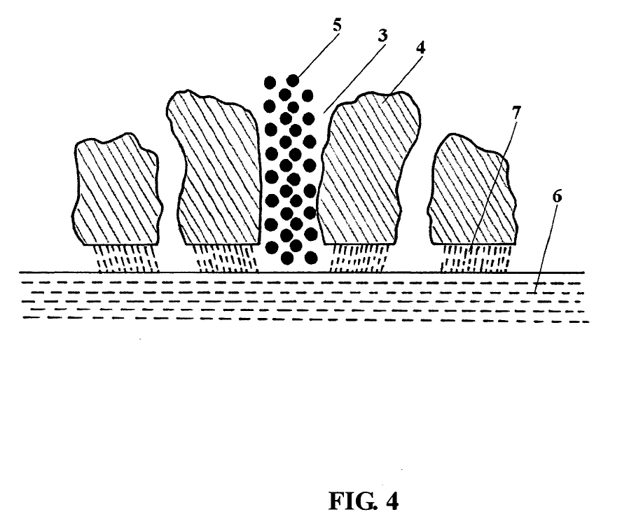

FIG. 4 shows a cross-sectional side view of a hurricane over sea water 6 with jet planes 5 flying through out the eye 3 of the hurricane to bring about increase in pressure in the eye, thereby reducing strength of the hurricane.

According to ideal gas law

PV=nRT

Where P is the absolute pressure of the gas

V is the volume of the gas

n is the number of moles of gas

R is the universal gas constant and

T is the absolute temperature

In a well-formed hurricane, the eye 3 is well-defined with structured eyewall 4. The air volume within the eye can be essentially assumed to be constant as the bottom of the eye is sealed with rain 7 and sea water 6. So pressure is directly proportional to temperature. As the temperature in the eye increases by flying jet planes with afterburners, pressure in the eye increases. The hurricane's lowest barometric pressure occurs in the eye, and can be as much as 15% lower than the atmospheric pressure outside the storm. Thus, increasing pressure within the eye will diminish the strength of the hurricane.

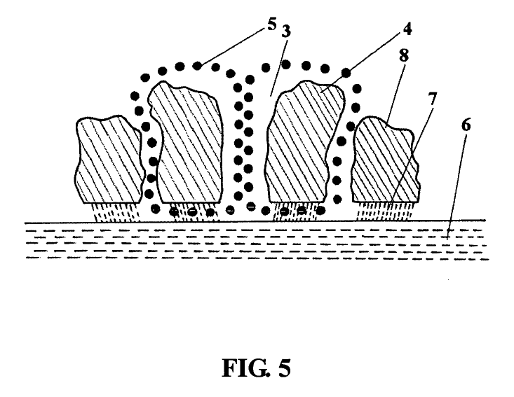

FIG. 5 shows the jet planes flying in the center of the eye 3 from the bottom of the eye to the top of the eye. The planes enter bottom of the eye and return through space between the eyewall 4 and rain bands 8. Any other convenient path may be chosen.

Similarly, the jet planes can fly in the center of the eye from the top of the eye to the bottom of the eye in any suitable path.

It is to be understood that illustrations described herein convey the concept of this invention, it is not to be limited to the specific forms herein described. It will be apparent to those skilled in the art that various changes may be made without departing from the scope of the invention and the invention is not to be considered limited to what is shown in the drawings and described in the specification. For example, the same techniques of flying jet planes may be used to control tornadoes by raising temperatures in and around the storm structure.

What is claimed is:

1. A method for controlling hurricanes by raising temperature in the eye and/or in the outflow of the hurricane by flying a fleet of jet planes with afterburners in the structure.

2. The method of claim 1 where the jet planes are fighter planes Super Hornet F/A-18.

3. The method of claim 1 where jet planes with afterburners fly in concentric formations in the outflow above the eye of the hurricane.

4. The method of claim 1 where the jet planes fly in small groups in selected positions near or top of the eyewall near the eye of the hurricane.

5. The method of claim 1 where the jet planes fly through out the eye of the hurricane.

6. The method of claim 1 where the jet plane is any plane with afterburner.

7. The method of claim 1 where the jet plane is any plane without afterburner.

8. The method of claim 1 where the jet planes fly in the center of the eye from the bottom of the eye to the top of the eye.

9. The method of claim 1 where the jet planes fly in the center of the eye from the top of the eye to the bottom of the eye.

10. The method of claim 1 where the jet planes fly in any selected formation to bring about the change in temperature and thereby change in direction of travel of the hurricane.

11. The method of weather modification wherein the same techniques of flying jet planes may be used to control tornadoes by raising temperatures in and around the storm structure.
